(19) United States
(12) Patent Application Publication
(10) Pub. No.: US 2018/0273778 A1
(43) Pub. Date: Sep. 27, 2018

(54) RADIATION CURING TYPE INK JET INK COMPOSITION AND INK JET RECORDING METHOD

(71) Applicant: Seiko Epson Corporation, Tokyo (JP)

(72) Inventors: Toru SAITO, Yamagata-mura (JP); Keitaro NAKANO, Matsumoto (JP); Toshiyuki YODA, Matsumoto (JP); Hitoshi TSUCHIYA, Chino (JP); Kyohei TANAKA, Matsumoto (JP)

(21) Appl. No.: 15/907,624

(22) Filed: Feb. 28, 2018

(30) Foreign Application Priority Data
Mar. 24, 2017 (JP) 2017-059852

(51) Int. Cl. C09D 11/101; C09D 11/322; C09D 11/037; C08F 220/28; C08F 220/30; C09D 11/107; B41M 5/00; B41M 7/00

(52) U.S. Cl. CPC C09D 11/101; C09D 11/322; C09D 11/037; C08F 220/28; C08K 2003/2241; C09D 11/107; B41M 5/0023; B41M 7/0081; C08F 220/30

(57) ABSTRACT

Provided is a radiation curing type ink jet ink composition simultaneously satisfying excellent adhesiveness of a cured film to a recording medium, excellent hardenability, and excellent flexibility of the cured film in a well-balanced state. The composition includes a (meth)acrylate monomer A including a vinyl ether group, a monofunctional (meth)acrylate monomer B including a cyclic ether skeleton having two or more ether groups, a monofunctional (meth)acrylate monomer C including an aromatic ring skeleton, and a photopolymerization initiator. The contents of the monomer A, the monomer B, and the monomer C are 5 to 35 mass %, 23 to 55 mass %, and 13 to 46 mass %, respectively, based on the total mass of the composition.

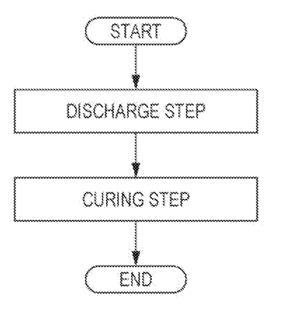

### BACKGROUND

### 1. Technical Field

The present invention relates to a radiation curing type ink jet ink composition and an ink jet recording method.

### 2. Related Art

As recording methods of forming images on recording media based on image data signals, for example, an ink jet system is known. The ink jet system discharges an ink to only the required image area with an inexpensive apparatus and directly forms an image on a recording medium, and therefore can efficiently use an ink composition and is low in running cost.

Recently, in order to form an image having, for example, excellent water resistance, solvent resistant, and abrasion resistance on a surface of a recording medium, a radiation curing type ink jet ink composition, which is cured by irradiation with radiation such as ultraviolet rays, is used in a recording method of an ink jet system.

JP-A-2013-18882 discloses an ink jet ink composition having excellent discharge stability and capable of providing a cured film having excellent adhesiveness to a base material and excellent shock resistance. This document discloses that the ink jet ink composition includes diethylene glycol monobutyl ether acrylate (component A-1), a component (component A-2) containing cyclic trimethylolpropane formal acrylate and phenoxyethyl acrylate, an N-vinyl lactam and/or tetrahydrofurfuryl acrylate (component A-3), and a polymerization initiator, wherein the content of the component A-1 is 1 to 35 mass % based on the total weight of the ink composition, and the total content of the components A-1 to A-3 is 60 to 90 mass % based on the total weight of the ink composition.

JP-A-2012-46724 discloses use of an ink composition having excellent curing sensitivity and discharge stability and capable of providing a cured film having excellent flexibility and adhesiveness to a recording medium, for providing an ink jet recording method that can achieve compatibility between excellent image quality and high productivity. This document discloses that the ink composition includes a polymerizable composition (component A) containing an N-vinyl lactam (component A-1), a monofunctional (meth)acrylate (component A-2) having two ether groups in an alicyclic structure, and a polyfunctional (meth)acrylate (component A-3); and a polymerization initiator (component B) containing an acylphosphine compound (component B-1) and a thioxanthone compound (component B-2).

However, the ink composition described in JP-A-2013-18882 does not necessarily provide sufficient flexibility to a cured film. The ink composition described in JP-A-2012-46724 is required to be further improved in the adhesiveness, hardenability, and flexibility.

### SUMMARY

An advantage of some aspects of the invention is to provide a radiation curing type ink jet ink composition simultaneously satisfying excellent adhesiveness of a cured film to a recording medium, excellent hardenability, and excellent flexibility of the cured film in a well-balanced state, and an ink jet recording method using the composition.

The present inventors have diligently studied to solve the above-described problems and as a result, have found that a radiation curing type ink jet ink composition simultaneously satisfying excellent adhesiveness of a cured film to a recording medium, excellent hardenability, and excellent flexibility of the cured film in a well-balanced state can be obtained by combining a specific (meth)acrylate monomer having a vinyl ether group, a (meth)acrylate monomer including a cyclic ether skeleton having two or more ether groups, and a monofunctional (meth)acrylate monomer including an aromatic skeleton at a predetermined proportion, and have accomplished the invention.

That is, the radiation curing type ink jet ink composition according to an aspect of the invention includes a monomer A represented by Formula (I):

CH₂═CR¹—COOR²—O—CH═CH—R³

a monofunctional (meth)acrylate monomer B including a cyclic ether skeleton having two or more ether groups, a monofunctional (meth)acrylate monomer C including an aromatic ring skeleton, and a photopolymerization initiator, wherein the content of the monomer A is 5 to 35 mass % based on the total mass of the composition, the content of the monomer B is 23 to 55 mass % based on the total mass of the composition, and the content of the monomer C is 13 to 46 mass % based on the total mass of the composition; and in Formula (I), R¹ represents a hydrogen atom or a methyl group, R² represents a divalent organic residue having 2 to 20 carbon atoms, and R³ represents a hydrogen atom or a monovalent organic residue having 1 to 11 carbon atoms.

The factors of the composition of the invention that can solve the above-described problems are conceived, but not limited to, as follows: The composition can provide improved adhesiveness of a cured film to a recording medium mainly by including the monomer B in a relatively large amount and can provide compatibility between the hardenability and the flexibility of a cured film in a well-balanced state mainly by including the monomer A in a relatively small amount and including the monomer B and the monomer C in relatively large amounts.

In the radiation curing type ink jet ink composition according to the invention, the content of the monomer A is preferably 10 to 30 mass % based on the total mass of the composition; the content of the monomer B is preferably 25 to 50 mass % based on the total mass of the composition; and the content of the monomer C is preferably 18 to 45 mass % based on the total mass of the composition. Furthermore, the monomer B is preferably at least one selected from the group consisting of cyclic trimethylolpropane formal acrylate, 4-acryloyloxymethyl-2-methyl-2-ethyl-1,3-dioxolane, and 4-acryloyloxymethyl-2-cyclohexyl-1,3-dioxolane. The composition preferably further contains a color material, and the color material preferably includes a white pigment. The content of the color material is preferably 5 to 30 mass % based on the total mass of the composition. Alternatively, it is also preferred that the content of the color material is 0.5 mass % or less based on the total mass of the composition and that the ink jet composition is a clear ink composition. The content of a nitrogen-containing monomer is preferably 5 mass % or less based on the total mass of the composition, which will be described in detail later. Furthermore, the photopolymerization initiator preferably includes an acylphosphine oxide compound, and the content of the acylphosphine oxide compound is preferably 9 mass % or less based on the total mass of the composition. The acylphosphine oxide compound preferably includes a bisacylphosphine oxide compound and a monoacylphosphine oxide compound. The photopolymerization initiator preferably includes a thioxanthone compound, and the content of the thioxanthone compound is 1 mass % or less based on the total mass of the composition. The mass ratio of the monomer B to the monomer C (monomer B/monomer C) is preferably 0.7 to 3.0.

Furthermore, the ink jet recording method according to the invention includes a discharge step of discharging the radiation curing type ink jet ink composition according to the invention onto a recording medium and a curing step of irradiating the composition discharged in the discharge step with radiation and curing the composition. In the ink jet recording method according to the invention, the irradiation energy in the curing step is preferably less than 800 mJ/cm².

### BRIEF DESCRIPTION OF THE DRAWINGS

The invention will be described with reference to the accompanying drawing.

FIGURE is a flow chart showing an example of the ink jet recording method of an embodiment.

### DESCRIPTION OF EXEMPLARY EMBODIMENTS

Embodiments of the invention (hereinafter, referred to “the embodiment”) will now be described in detail, but the invention is not limited thereto and can be variously modified within a range not departing from the gist of the invention.

In the specification, the term “adhesiveness” of a cured film refers to a characteristic that a cured film obtained by curing a composition adhered on a recording medium is hardly peeled off from the recording medium. The term “hardenability” refers to a characteristic that a composition responses to light and is cured. The term “flexibility” of a cured film refers to a characteristic that cracking or peeling hardly occurs when a cured film (hereinafter, also referred to as “coating film”) is extended and means a characteristic that the cured film is hardly peeled off from the recording medium, for example, even if the recording medium to which the cured film adhered is bent. In the specification, “flexibility of a cured film” may be referred to as “extension of a coating film”.

Throughout the specification, the term “(meth)acrylate” refers to at least any of acrylates and methacrylates corresponding to the respective acrylates, and the term “(meth)acrylic” refers to at least any of acrylic and methacrylic corresponding to the acrylic.

### Radiation Curing Type Ink Jet Ink Composition

The radiation curing type ink jet ink composition of the embodiment (hereinafter, also referred to as “composition”) contains a monomer A represented by Formula (I):

CH₂═CR¹—COOR²—O—CH═CH—R³

(hereinafter, also referred to as “vinyl ether group-containing (meth)acrylate monomer”), a monofunctional (meth)acrylate monomer B including a cyclic ether skeleton having two or more ether groups (hereinafter, also referred to as “(meth)acrylate including a cyclic skeleton containing two or more ether groups”), a monofunctional (meth)acrylate monomer C including an aromatic ring skeleton (hereinafter, also referred to as “aromatic ring skeleton-containing (meth)acrylate monomer”), and a photopolymerization initiator. The content of the monomer A is 5 to 35 mass % based on the total mass of the composition, the content of the monomer B is 23 to 55 mass % based on the total mass of the composition, and the content of the monomer C is 13 to 46 mass % based on the total mass of the composition. Herein, in Formula (I), R¹ represents a hydrogen atom or a methyl group, R² represents a divalent organic residue having 2 to 20 carbon atoms, and R³ represents a hydrogen atom or a monovalent organic residue having 1 to 11 carbon atoms.

The factors of the composition that can simultaneously satisfy excellent adhesiveness of a cured film, excellent hardenability, and excellent flexibility of the cured film in a well-balanced state are conceived, but not limited to, as follows: The adhesiveness of a cured film of the composition to a recording medium is improved mainly by containing the monomer B including a cyclic skeleton having two or more ether groups in a relatively large amount. The composition can provide compatibility between the hardenability and the flexibility of a cured film in a well-balanced state mainly by including the monomer A having two polymerizable groups in a relatively small amount and including the monomer B and the monomer C as monofunctional (meth)acrylate monomers in relatively large amounts.

The components of the composition of the embodiment will now be described.

### Polymerizable Compound

The composition of the embodiment at least includes the monomers A, B, and C as polymerizable compounds. The polymerizable compounds polymerize by the effect of a photopolymerization initiator during light irradiation, leading to curing of the printed ink.

### Monomer A

The monomer A is a specific (meth)acrylate compound containing a vinyl ether group in the molecule, and is represented by Formula (I). The monomer A is a single (meth)acrylate compound or a combination of different (meth)acrylate compounds.

The composition can have good hardenability by containing the monomer A. In addition, the composition can provide an ink having a lower viscosity by containing the monomer A.

In Formula (I), R¹ is preferably a hydrogen atom from the viewpoint of more effectively and certainly achieving the effects of the invention.

In Formula (I), the divalent organic residue represented by R² may be any divalent organic residue, and examples thereof include an optionally substituted linear or branched alkylene group having 2 to 20 carbon atoms, and a group represented by —R⁴ (O—R⁵)ₚ— (where, R⁴ and R⁵ each independently represent an optionally substituted linear or branched alkylene group having 1 to 10 carbon atoms, and p is 1 to 10). Among these divalent organic residues, the divalent organic residue represented by R² is preferably a group represented by —R⁴—(O—R⁵)ₚ— from the viewpoint of more effectively and certainly achieving the effects of the invention.

From the viewpoint of more effectively and certainly achieving the effects of the invention, R⁴ and R⁵ are each independently, preferably, an alkylene group having 1 to 6 carbon atoms, more preferably an ethylene group, an n-propylene group, an isopropylene group, or a butylene group, and most preferably an ethylene group. From the same viewpoint, p is preferably 1 to 6, more preferably 1 to 4, and most preferably 1 to 3.

In Formula (I), the monovalent organic residue having 1 to 11 carbon atoms represented by R³ may be any monovalent organic residue, and examples thereof include an optionally substituted linear or branched alkyl group having 1 to 11 carbon atoms. Among these monovalent organic residues, from the viewpoint of more effectively and certainly achieving the effects of the invention, the divalent organic residue represented by R³ is preferably an alkyl group having 1 to 2 carbon atoms, i.e., a methyl group or an ethyl group.

When each of the organic residues is an optionally substituted group, examples of the substituent include, but not limited to, a hydroxy group and a halogen atom.

Examples of the compound as the monomer A represented by Formula (I) include, but not limited to, 2-(vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. These compounds may be prepared in accordance with a known method or may be commercially available products. These compounds are used alone or in combination of two or more thereof.

From the viewpoint of more effectively and certainly achieving the effects of the invention, among these compounds, the monomer A is preferably one or more selected from the group consisting of 2-(vinyloxyethoxy)ethyl (meth)acrylate, 2-(vinyloxyethoxyethoxy)ethyl (meth)acrylate, and 2-(vinyloxyethoxyethoxyethoxy)ethyl (meth)acrylate. Furthermore, from the viewpoint of a lower viscosity, a high flash point, and further excellent hardenability, the monomer A is preferably 2-(vinyloxyethoxy)ethyl (meth)acrylate.

Examples of 2-(vinyloxyethoxy)ethyl (meth)acrylate include 2-(2-vinyloxyethoxy)ethyl (meth)acrylate and 2-(1-vinyloxyethoxy)ethyl (meth)acrylate; and examples of 2-(vinyloxyethoxy)ethyl acrylate include 2-(2-vinyloxyethoxy)ethyl acrylate and 2-(1-vinyloxyethoxy)ethyl acrylate.

Among these compounds, more preferred are 2-(2-vinyloxyethoxy)ethyl acrylate and 2-(1-vinyloxyethoxy)ethyl acrylate from the viewpoint of a lower odor, excellent reactivity, and further excellent adhesiveness of a cured film.

The content of the monomer A is 5 to 35 mass %, preferably 8 to 32 mass %, and more preferably 10 to 30 mass % based on the total mass of the composition. When this content is 5 mass % or more, good hardenability and a reduction in the viscosity of the ink can be achieved. When the content is 35 mass % or less, good flexibility of a cured film can be achieved. In particular, when the content of the monomer A is 10 to 30 mass % based on the total mass of the composition, excellent hardenability, a reduction in the viscosity of the ink, and excellent flexibility of a cured film can be simultaneously satisfied in a further well-balanced state.

### Monomer B

The monomer B is a monofunctional (meth)acrylate compound including a cyclic ether skeleton having two or more ether groups. The monomer B is a single (meth)acrylate compound or a combination of different (meth)acrylate compounds.

The composition can provide good adhesiveness of a cured film to a recording medium by containing the monomer B. In addition, the composition containing the monomer B can provide an ink having a lower viscosity and can further suppress the yellowing of a cured film. The factors thereof are conceived, but not limited to, that the monomer B has a cyclic structure and has two or more ether groups, in particular, since the monomer B has a cyclic structure, the yellowing can be suppressed and since the monomer B has two or more ether groups, good adhesiveness of a cured film to a recording medium can be provided. In addition, the monomer B is less volatile and has a lower odor. The factor thereof is conceived, but not limited to, that the monomer B has a large polarity as a molecule.

The monomer B preferably does not contain a nitrogen atom from the viewpoint of further suppressing the yellowing of a cured film.

The number of the ether groups in the cyclic skeleton may be two or more and is preferably two.

Examples of the (meth)acrylate including a cyclic skeleton containing two ether groups include, but not limited to, dioxane (meth)acrylate and dioxolane (meth)acrylate.

The dioxane (meth)acrylate is a (meth)acrylate compound containing a 1,3-dioxane ring. Preferred examples of the dioxane (meth)acrylate include, but not limited to, compounds represented by Formula (II):

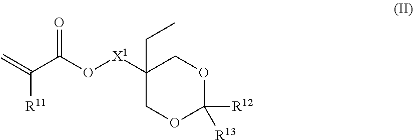

where, R¹¹, R¹², and R¹³ each independently represent a hydrogen atom, a methyl group, or an ethyl group; and X¹ represents a single bond or a divalent linking group.

In Formula (II), R¹¹, R¹², and R¹³ are each independently, preferably, a hydrogen atom or a methyl group and, more preferably, a hydrogen atom, from the viewpoint of more effectively and certainly achieving the effects of the invention. In particular, R¹¹, R¹², and R¹³ are preferably hydrogen atoms.

In Formula (II), X¹ is preferably a single bond, a divalent hydrocarbon group, or a divalent group composed of a hydrocarbon group and an ether bond; more preferably a divalent hydrocarbon group having 1 to 20 carbon atoms; more preferably a divalent hydrocarbon group having 1 to 8 carbon atoms; and most preferably a methylene group.

Examples of the compound represented by Formula (II) include compounds represented by Formulae (II-a), (II-b), (II-c), (II-d), (II-e), (II-f), and (II-g). In each Formula, R represents a hydrogen atom or a methyl group, and in Formula (II-g), n is 1 to 30.

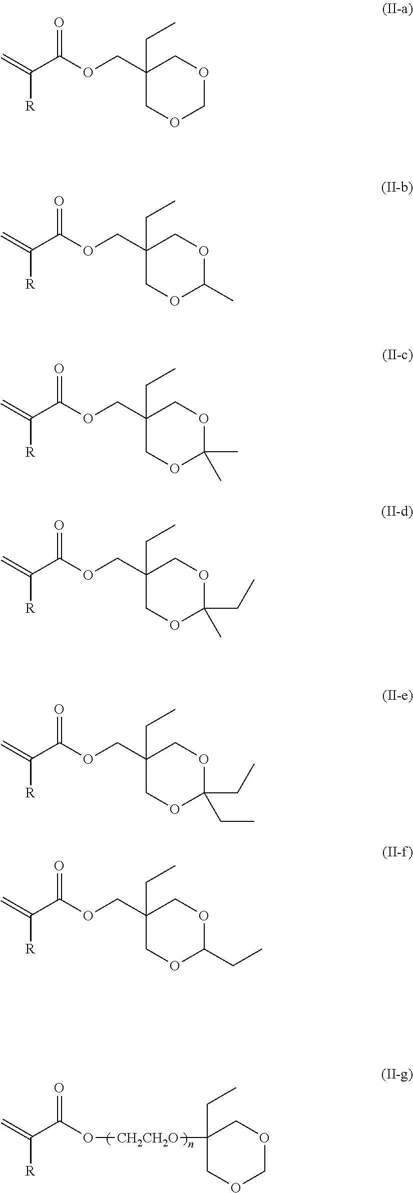

These compounds may be used alone or in a combination of two or more thereof. These compounds may be prepared in accordance with a known method or may be commercially available products.

Among these compounds, cyclic trimethylolpropane formal (meth)acrylate, which is a compound represented by Formula (II-a), is preferred from the viewpoint of more effectively and certainly achieving the effects of the invention; and cyclic trimethylolpropane formal acrylate is more preferred from the viewpoint of more excellent reactivity and adhesiveness of a cured film.

The dioxolane (meth)acrylate is a (meth)acrylate compound containing a 1,3-dioxolane ring. Examples of the (meth)acrylate compound containing a 1,3-dioxolane ring include, but not limited to, 4-(meth)acryloyloxymethyl-2-methyl-2-ethyl-1,3-dioxolane, 4-(meth)acryloyloxymethyl-2-cyclohexyl-1,3-dioxolane, 4-(meth)acryloyloxymethyl-2-methyl-2-methyl-1,3-dioxolane, 4-(meth)acryloyloxymethyl-2-methyl-2-isobutyl-1,3-dioxolane, 4-(meth)acryloyloxymethyl-2-methyl-2-acetonyl-1,3-dioxolane, 4-(meth)acryloyloxymethyl-2-oxo-1,3-dioxolane, 2-(meth)acryloyloxyethyl-2-oxo-1,3-dioxolan-4-ylmethylcarbonate, and 2-oxo-1,3-dioxolan-4-ylmethyl-3-(meth)acryloyloxypropionate. These compounds may be prepared in accordance with a known method or may be commercially available products. These compounds are used alone or in combination of two or more thereof.

Among these compounds, 4-acryloyloxymethyl-2-methyl-2-ethyl-1,3-dioxolane and 4-acryloyloxymethyl-2-cyclohexyl-1,3-dioxolane are preferred from the viewpoint of further excellent hardenability and adhesiveness of a cured film, a lower viscosity, and a lower odor.

Among these dioxane (meth)acrylates and dioxolane (meth)acrylates, the monomer B is preferably at least one selected from the group consisting of cyclic trimethylolpropane formal acrylate, 4-acryloyloxymethyl-2-methyl-2-ethyl-1,3-dioxolane, and 4-acryloyloxymethyl-2-cyclohexyl-1,3-dioxolane, from the viewpoint of more effectively and certainly achieving the effects of the invention.

The content of the monomer B is 23 to 55 mass % based on the total mass of the composition, preferably 24 to 52 mass %, and more preferably 25 to 50 mass %. When the content is 23 mass % or more, good adhesiveness of a cured film is provided. When the content is 55 mass % or less, the solubility of the photopolymerization initiator is further increased.

### Monomer C

The monomer C is a monofunctional (meth)acrylate monomer including an aromatic skeleton. The monomer C is a single (meth)acrylate monomer or a combination of different (meth)acrylate monomers.

The composition can provide excellent flexibility of a cured film and increase the solubility of the photopolymerization initiator by containing the monomer C.

Examples of the aromatic skeleton-containing monofunctional (meth)acrylate monomer include, but not limited to, compounds represented by Formula (III):

CH₂═CR²¹—COO—X²—Ar

where, R²¹ represents a hydrogen atom or a methyl group; X² represents a divalent linking group; and Ar represents an optionally substituted aromatic hydrocarbon group.

In Formula (III), R²¹ is preferably a hydrogen atom from the viewpoint of more effectively and certainly achieving the effects of the invention.

In Formula (III), the divalent linking group represented by X² is preferably an ether bond (—O—), an ester bond (—C(O)O— or —OC(O)—), a carbonyl group (—C(O)—), an optionally substituted alkylene group having 1 to 10 carbon atoms, or a divalent group composed of two or more thereof, from the viewpoint of more effectively and certainly achieving the effects of the invention; and more preferably an oxyalkylene group or alkylene group having 1 to 5 carbon atoms. Examples of the substituent include a hydroxy group and a halogen atom.

From the viewpoint of more effectively and certainly achieving the effects of the invention, in Formula (III), Ar is preferably a phenyl group or a naphthyl group and more preferably a phenyl group. When Ar is a naphthyl group, the divalent linking group may bind to the 1-position or the 2-position of the naphthyl group. When Ar is a substituted aromatic hydrocarbon group, the number of the substituents is not particularly limited and is, for example, 1 to 5. When the number of the substituents is two or more, the substituents may be the same or different. Examples of the substituent include an alkyl group having 1 to 10 carbon atoms, an aryl group having 6 to 12 carbon atoms, a hydroxy group, and a halogen atom.

Examples of the monomer C represented by Formula (III) include, but not limited to, 2-phenoxyethyl (meth)acrylate and benzyl (meth)acrylate. These compounds may be prepared in accordance with a known method or may be commercially available products. These compounds are used alone or in combination of two or more thereof.

Among these monofunctional (meth)acrylates, the monomer C is preferably 2-phenoxyethyl (meth)acrylate from the viewpoint of a lower odor and is more preferably 2-phenoxyethyl acrylate from the viewpoint of better reactivity.

The content of the monomer C is 13 to 46 mass % based on the total mass of the composition, preferably 15 to 45.5 mass %, and more preferably 18 to 45 mass %. When the content is 13 mass % or more, the solubility of the photopolymerization initiator can be increased. When the content is 46 mass % or less, the yellowing of a cured film can be sufficiently suppressed. The content of the monomer C is preferably 40 mass % or less based on the total mass of the composition, more preferably 35 mass % or less, and most preferably 30 mass % or less, from the viewpoint of further suppressing the yellowing of a cured film.

It is preferred that the content of the monomer B is 25 to 50 mass % based on the total mass of the composition and the content of the monomer C is 18 to 45 mass % based on the total mass of the composition. When the contents of the monomer B and the monomer C are within the above-mentioned ranges, the adhesiveness of a cured film, the solubility of the photopolymerization initiator, and the suppression of the yellowing of a cured film can be simultaneously increased in a well-balanced state.

The mass ratio of the monomer B to the monomer C (monomer B/monomer C) is preferably 0.7 to 3.0, more preferably 0.75 to 2.85, and most preferably 0.78 to 2.7. When this mass ratio is 0.7 or more, the adhesiveness of a cured film can be further increased. When the ratio is 3.0 or less, the solubility of the photopolymerization initiator can be further increased.

### Other Polymerizable Compound Components

The composition may include an additional polymerizable compound that can polymerize during light irradiation, in addition to the above-mentioned polymerizable compounds. Such an additional polymerizable compound is, for example, a monofunctional or polyfunctional monomer or monofunctional or a polyfunctional oligomer. Examples of the monomer include unsaturated carboxylic acid, such as (meth)acrylic acid, itaconic acid, crotonic acid, isocrotonic acid, and maleic acid, and salts or esters thereof; urethane; styrene; unsaturated polyester; unsaturated polyether; and unsaturated urethane. Examples of the oligomer include oligomers formed from the above-mentioned monomers, such as a linear acrylic oligomer, epoxy (meth)acrylate, aliphatic urethane (meth)acrylate, aromatic urethane (meth)acrylate, and polyester (meth)acrylate.

The content of the additional polymerizable compound is preferably 25 mass % or less, more preferably 10 mass % or less, more preferably 5 mass % or less, and more preferably 1 mass % or less, based on the total mass of the composition. Most preferably, the composition does not include such an additional polymerizable compound.

The composition may or may not include an N-vinyl compound as an additional monofunctional or polyfunctional monomer. Examples of the N-vinyl compound include N-vinylcaprolactam, N-vinylformamide, N-vinylcarbazole, N-vinylacetamide, N-vinylpyrrolidone, acryloylmorpholine, and derivatives thereof.

In general, as described in JP-A-2013-18882 and JP-A-2012-46724, a composition containing an N-vinyl compound has an advantage that the adhesiveness of a cured film is improved. However, a composition including a nitrogen-containing monomer such as the N-vinyl compound is apt to cause yellowing of a cured film. In contrast, the composition of the embodiment can provide good adhesiveness to a cured film, even if a nitrogen-containing monomer is not included. The factor thereof is conceived, but not limited to, that the content of the monomer B is relatively large. Accordingly, the composition of the embodiment can simultaneously increase the suppression of the yellowing of a cured film and the adhesiveness of the cured film in a well-balanced state.

When the composition includes a chromatic color material, it is also preferred to include an N-vinyl compound. In the composition including a chromatic color material, yellowing may not be a problem in some cases, compared to a clear ink composition or a white ink composition. When an N-vinyl compound is included, the content of the N-vinyl compound is preferably 0.1 mass % or more, more preferably 0.5 mass % or more, and most preferably 0.5 mass % or more and 5 mass % or less based on the total mass of the composition.

The content of the nitrogen-containing monomer is preferably 5 mass % or less, more preferably 1 mass % or less, and more preferably 0.5 mass % or less based on the total mass of the composition; and most preferably, the composition does not include the nitrogen-containing monomer, from the viewpoint of suppressing the yellowing of a cured film. The composition of the embodiment can provide sufficient adhesiveness to a cured film even if the content of the nitrogen-containing monomer is 5 mass % or less.

### Photopolymerization Initiator

The composition of the embodiment includes a photopolymerization initiator. The initiation of polymerization of the polymerizable compounds can be easily controlled by using the photopolymerization initiator. The photopolymerization initiator is a single initiator or a combination of two or more initiators.

The photopolymerization initiator is used for forming an image by curing the ink present on a surface of a recording medium through photopolymerization by irradiation with ultraviolet light. The photopolymerization initiator may be any initiator that generates an active species, such as a radical and a cation, by the energy of light and initiates polymerization of the polymerizable compounds. Examples of the photopolymerization initiator include a photoradical polymerization initiator and a photocationic polymerization initiator. In particular, a photoradical polymerization initiator is preferred.

Examples of the photoradical polymerization initiator include an aromatic ketones, an aromatic onium salt compound, an organic hyperoxide, a thiophenyl group-containing compound, a hexaarylbiimidazole compound, a ketoxime ester compound, a borate compound, an azinium compound, a metallocene compound, an active ester compound, a compound having a carbon-halogen bond, an alkylamine compound, an acylphosphine oxide compound, and a thioxanthone compound.

Among these polymerization initiators, at least one of the acylphosphine oxide compound and the thioxanthone compound is preferred, in particular, from the viewpoint of being capable of further improving the hardenability of the ink.

### Acylphosphine Compound

Examples of the acylphosphine compound include a monoacylphosphine oxide compound and a bisacylphosphine oxide compound.

Examples of the monoacylphosphine oxide compound include, but not limited to, 2,4,6-trimethylbenzoyl diphenylphosphine oxide, 2,4,6-triethylbenzoyl diphenylphosphine oxide, and 2,4,6-triphenylbenzoyl diphenylphosphine oxide. These compounds are used alone or in combination of two or more thereof.

Examples of the commercially available products of the monoacylphosphine oxide compound include, but not limited to, DAROCUR TPO (2,4,6-trimethylbenzoyl diphenylphosphine oxide).

Among these compounds, the monoacylphosphine oxide compound is preferably 2,4,6-trimethylbenzoyl diphenylphosphine oxide.

Examples of the bisacylphosphine oxide compound include, but not limited to, bis-(2,4,6-trimethylbenzoyl)-phenylphosphine oxide and bis-(2,6-dimethoxybenzoyl)-2,4,4-trimethylpentylphosphine oxide. These compounds are used alone or in combination of two or more thereof.

Examples of the commercially available product of the bisacylphosphine oxide compound include, but not limited to, IRGACURE 819 (bis(2,4,6-trimethylbenzoyl)-phenylphosphine oxide).

Among these compounds, the bisacylphosphine oxide compound is preferably bis-(2,4,6-trimethylbenzoyl)-phenylphosphine oxide.

Examples of the commercially available product of the bisacylphosphine oxide compound include, but not limited to, IRGACURE 819 (bis(2,4,6-trimethylbenzoyl)-phenylphosphine oxide).

The content of the acylphosphine oxide compound is preferably higher than 0 mass % and not higher than 9 mass %, based on the total mass of the composition, and more preferably 0.1 to 7 mass %, and most preferably 1 to 5 mass %. When the content is 9 mass % or less, suppression of the yellowing of a cured film by containing the acylphosphine oxide compound can be more sufficiently achieved.

The acylphosphine oxide compound preferably includes a bisacylphosphine oxide compound and a monoacylphosphine oxide compound. A combination of the bisacylphosphine oxide compound and the monoacylphosphine oxide compound further increases the effect of the monomer C on the solubility of the photopolymerization initiator, compared to the case of using the bisacylphosphine oxide compound alone or the monoacylphosphine oxide compound alone. When the bisacylphosphine oxide compound, such as bis-(2,4,6-trimethylbenzoyl)-phenylphosphine oxide, is used, the polymerization can be easily initiated with a relatively low amount. However, there is a limit to the solubility of the bisacylphosphine oxide compound in a monomer, and when a large amount of the compound is added, the dissolution may take a long time or a small change in temperature may cause precipitation. In contrast, the monoacylphosphine oxide compound has good solubility in a monomer, although its photoreactivity is slightly lower than that of the bisacylphosphine oxide compound. Accordingly, a combination of these compounds can satisfy good photoreactivity and initiator solubility in a well-balanced state.

### Thioxanthone Compound

The thioxanthone compound is preferably 2,4-diethylthioxanthone from the viewpoint of improving the susceptibility to acylphosphine oxide and the solubility in the polymerizable compound.

Examples of the commercially available product of the thioxanthone compound include “KAYACURE DETX-S” (2,4-diethylthioxanthone).

The content of the thioxanthone compound is preferably higher than 0 mass % and not higher than 1 mass %, based on the total mass of the composition, and more preferably 0.01 to 0.95 mass % and most preferably 0.05 to 0.90 mass %. When the content of the thioxanthone compound is 1 mass % or less, suppression of the yellowing of a cured film by containing the thioxanthone compound can be more sufficiently achieved.

### Color Material

The composition of the embodiment may be a color ink composition further containing a color material or may be a clear ink composition. The color material can be at least one of pigment and dye (for example, acid dye, direct dye, reactive dye, and basic dye). The color material preferably includes pigment, from the viewpoint of improving the light resistance.

### Pigment

The pigment may be inorganic pigment or organic pigment (for example, azo pigment, polycyclic pigment, dye chelate, dye lake, nitro pigment, nitroso pigment, aniline black, and daylight fluorescent pigment).

The inorganic pigment is not particularly limited, and examples thereof include the followings.

Examples of the pigment to be used in a black ink include carbon black. Examples of the carbon black include, but not limited to, No. 2300, No. 900, MCF88, No. 33, No. 40, No. 45, No. 52, MA7, MA8, MA100, and No. 2200B (these products are manufactured by Mitsubishi Chemical Corporation); Raven 5750, Raven 5250, Raven 5000, Raven 3500, Raven 1255, and Raven 700 (these products are manufactured by Carbon Columbia); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (these products are manufactured by CABOT JAPAN K.K.); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (these products are manufactured by Degussa).

Examples of the pigment to be used in a white ink include, but not limited to, C.I. Pigment White 6, 18, and 21, titanium oxide, zinc oxide, zinc sulfide, antimony oxide, zirconium oxide, white hollow resin particles, and polymer particles.

Examples of the pigment to be used in a yellow ink include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of the pigment to be used in a magenta ink include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245; and C.I. Pigment Violet 19, 23, 32, 33, 36, 38, 43, and 50.

Examples of the pigment to be used in a cyan ink include C.I. Pigment Blue 1, 2, 3, 15, 15:1, 15:2, 15:3, 15:34, 15:4, 16, 18, 22, 25, 60, 65, and 66; and C.I. Vat Blue 4 and 60.

Examples of the pigment other than magenta, cyan, and yellow include C.I. Pigment Green 7 and 10; C.I. Pigment Brown 3, 5, 25, and 26; C.I. Pigment Orange 1, 2, 5, 7, 13, 14, 15, 16, 24, 34, 36, 38, 40, 43, and 63.

These pigments are used alone or in combination of two or more thereof.

When the pigment is used, the average particle diameter thereof is preferably 300 nm or less and more preferably 50 to 250 nm. When the average particle diameter is within this range, the composition has further excellent reliability, such as discharge stability and dispersion stability, and can form higher quality images. The average particle diameter is measured by dynamic light scattering.

Among these pigments, ink composition (color ink composition) is preferably a white ink composition containing white pigment, from the viewpoint of being capable of more sufficiently suppressing the yellowing of a cured film. The composition of the embodiment can sufficiently suppress the yellowing of a cured film and therefore can be suitably used as a white ink composition.

The content of the color material (for example, white pigment) in the ink composition (color ink composition) is preferably 5 to 30 mass %, more preferably 10 to 25 mass %, and most preferably 12 to 20 mass % based on the total mass of the composition, from the viewpoint of further sufficiently showing the effects of the monomers A, B, and C. In particular, when the color material is white pigment, the content of the white pigment is preferably 10 mass % or more, more preferably 12 mass % or more, and most preferably 13 mass % or more based on the total mass of the composition. Even if the content of the white pigment is within the above-mentioned range, the composition of the embodiment can have good hardenability and adhesiveness and can have good color development, in particular, by the effects of the monomers A, B, and C.

The composition may be a clear ink composition (clear ink). The “clear ink” in the specification is not an ink to be used for coloring a recording medium and is an ink to be used for another purpose. Such a purpose is, for example, adjustment of the glossiness of a recording medium, improvement in characteristics such as the abrasion resistance of a recorded matter, and improvement in fixability and color development of a color ink. The clear ink composition may be an ink composition not substantially containing a color material.

The content of the color material in the clear ink composition is preferably 0.5 mass % or less and more preferably 0.1 mass % or less based on the total mass of the clear ink composition, and most preferably 0 mass %, that is, the color material is not included. When the content of the color material is 0.5 mass % or less, it can be defined that the color material is not substantially contained. The ink composition of the embodiment can more sufficiently suppress the yellowing of a cured film and therefore can also be suitably used as a clear ink composition.

### Polymerization Inhibitor

The composition of the embodiment may include a polymerization inhibitor. Examples of the polymerization inhibitor include, but not limited to, phenol compounds, such as p-methoxyphenol, cresol, t-butyl catechol, di-t-butyl paracresol, hydroquinone monomethyl ether, α-naphthol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol); quinone compounds, such as p-benzoquinone, anthraquinone, naphthoquinone, phenanthraquinone, p-xyloquinone, p-toluquinone, 2,6-dichloroquinone, 2,5-diphenyl-p-benzoquinone, 2,5-diacetoxy-p-benzoquinone, 2,5-dicaproxy-p-benzoquinone, 2,5-diacyloxy-p-benzoquinone, hydroquinone, 2,5-di-butylhydroquinone, mono-t-butylhydroquinone, monomethylhydroquinone, and 2,5-di-t-amylhydroquinone; amine compounds, such as phenyl-β-naphthylamine, p-benzylaminophenol, di-β-naphthylparaphenylenediamine, dibenzylhydroxylamine, phenylhydroxylamine, and diethylhydroxylamine; nitro compounds, such as dinitrobenzene, trinitrotoluene, and picric acid; oxime compounds, such as quinone dioxime and cyclohexanone oxime; and sulfur compounds, such as phenothiazine.

When the composition includes a polymerization inhibitor, the content of the polymerization inhibitor is, for example, about 0.01 to 0.1 mass % based on the total mass of the composition.

### Dispersing Agent

When the composition of the embodiment include pigment, the composition may further include a dispersing agent for increasing the pigment dispersibility. The dispersing agent is not particularly limited and is, for example, a dispersing agent that is commonly used for preparing a pigment dispersant, such as a polymer-dispersing agent. Examples of the dispersing agent include those mainly including at least one of polyoxyalkylene polyalkylene polyamine, vinyl polymer and copolymer, acrylic polymer and copolymer, polyester, polyamide, polyimide, polyurethane, amino polymer, silicon-containing polymer, sulfur-containing polymer, fluorine-containing polymer, and epoxy resin. Examples of the commercially available product of the polymer-dispersing agent include Ajisper series manufactured by Ajinomoto Fine-Techno Co., Ltd.; Solsperse series (e.g., Solsperse 36000) manufactured by The Lubrizol Corporation; DISPERBYK series manufactured by BYK-Chemie; and DISPARON series manufactured by Kusumoto Chemicals Ltd.

When the composition of the embodiment includes a dispersing agent, the content of the dispersing agent is, for example, about 0.2 to 15 mass % based on the total mass of the composition and may be about 0.2 to 5 mass %.

### Slipping Agent (Surfactant)

The composition of the embodiment may further include a slipping agent (surfactant). The slipping agent is not particularly limited. For example, silicone surfactants, such as polyester-modified silicone and polyether-modified silicone, can be used. Among these agents, particularly preferred are polyether-modified polydimethylsiloxane and polyester-modified polydimethylsiloxane. Commercially available examples thereof include BYK-377 and BYK-UV3500 (these products are manufactured by BYK-Chemie) and KF-615A (manufactured by Shin-Etsu Chemical Co., Ltd.).

When the composition of the embodiment include a slipping agent, the content of the slipping agent is, for example, 0.1 to 3 mass % based on the total mass of the composition.

### Other Additives

The composition of the embodiment may include an additive different from the above-mentioned additives. Such the additive is not particularly limited, and examples thereof include known polymerization accelerator, penetration accelerator, wetting agent (humectant), and other additives, such as known fixing agent, antifungal agent, preservative, antioxidant, ultraviolet absorber, chelating agent, pH adjuster, and thickener.

### Recording Medium

The recording medium refers to an object to which the radiation curing type ink jet ink composition of the embodiment is discharged by an ink jet recording method described later. The recording medium is, for example, an absorbing or non-absorbing recording medium. The ink jet recording method described later can be widely applied to a variety of recording media having various absorption properties, from a non-absorbing recording medium into which a composition hardly permeates to an absorbing recording medium to which a composition easily permeates.

The absorbing recording medium is not particularly limited, and examples thereof include plain paper, such as electrophotographic paper, having high aqueous ink permeability; ink jet paper (special paper for ink jet printing having an ink absorbing layer constituted of silica particles or alumina particles or an ink absorbing layer constituted of a hydrophilic polymer such as polyvinyl alcohol (PVA) or polyvinyl pyrrolidone (PVP)); and art paper, coated paper, and cast paper having relatively low aqueous ink permeability and used in ordinary offset printing.

The non-absorbing recording medium is not particularly limited, and examples thereof include films and plates of plastics such as polyvinyl chloride, polyethylene, polypropylene, and polyethylene terephthalate (PET); plates of metals such as iron, silver, copper, and aluminum; metal plates and plastic films coated with such various metals by vapor deposition; and plates of stainless steel and alloys such as brass. The composition of the embodiment can provide good adhesiveness of a cured film even on a non-absorbing recording medium, such as polyvinyl chloride.

### Ink Jet Recording Method

The ink jet recording method of the embodiment uses the radiation curing type ink jet ink composition of the embodiment. FIGURE is a flow chart showing an example of the ink jet recording method of the embodiment. As shown in FIGURE, the ink jet recording method of the embodiment includes a discharge step of discharging the composition of the embodiment onto a recording medium, and a curing step of irradiating the composition discharged in the discharge step with radiation and curing the composition. Thus, the composition cured on the recording medium forms a cured film.

### Discharge Step

In the discharge step, a known ink jet recording apparatus can be used. In the discharge of the composition, the composition preferably has a viscosity at 25° C. of less than 25 mPa·s and more preferably 10 mPa·s or more and less than 20 mPa·s. The viscosity of the composition within the above-mentioned range at 25° C. leads to a decrease in discharge defect, even if the temperature of the composition to be discharged is room temperature or the composition is discharged without being heated. In addition, even if the discharge is performed under heating for more certainly preventing discharge defects, the heating temperature can be low.

### Curing Step

Subsequently, in the curing step, the composition discharged onto a recording medium is irradiated with radiation and is thereby cured.

The radiation may be any radiation that can cause decomposition of the photopolymerization initiator included in the composition irradiated with the radiation to generate initiation species such as a radical, an acid, or a base. Examples of the radiation include α-rays, γ-rays, X-rays, ultraviolet light, visible light, and electron beams, and preferred is ultraviolet light.

In the curing step, the irradiation with radiation accelerates the polymerization of the polymerizable compound through the function of the initiation species. On this occasion, if the composition includes a sensitizing dye together with the photopolymerization initiator, the sensitizing dye in the system absorbs ultraviolet light and becomes into an excited state to accelerate decomposition of the photopolymerization initiator by being into contact with the photopolymerization initiator, resulting in more sensitive curing reaction.

As a radiation source, for example, a mercury lamp or a gas/solid laser is mainly used. As a light source for curing a radiation curing type ink jet ink composition, a mercury lamp and a metal halide lamp are well known. However, from the viewpoint of environmental protection, a mercury-free light source is highly demanded at present, and replacement by a GaN-based semiconductor ultraviolet light-emitting device is very useful industrially and environmentally. In addition, a ultraviolet light-emitting diode (UV-LED) and a ultraviolet laser diode (UV-LD) are small in size, long in life, high in efficiency, and low in cost, and are therefore preferred as a light source for radiation curing type ink jet recording. Among these light sources, particularly preferred is a UV-LED.

Herein, the radiation is preferably ultraviolet light having an emission peak wavelength preferably within a range of 360 to 420 nm and more preferably within a range of 385 to 405 nm. In such a case, the composition can be cured with lower energy and more rapidly due to the components of the composition of the embodiment.

The irradiation energy of the radiation is preferably less than 800 mJ/cm², more preferably less than 600 mJ/cm², and most preferably less than 400 mJ/cm². When the irradiation energy is less than 800 mJ/cm², the yellowing of a cured film can be sufficiently suppressed, and the curing reaction sufficiently proceeds to ensure the coating film quality. The irradiation energy can be calculated by multiplying the irradiation time by irradiation intensity.

The embodiment can provide a radiation curing type ink jet ink composition simultaneously satisfying excellent adhesiveness of a cured film to a recording medium, excellent hardenability, and excellent flexibility of the cured film in a well-balanced state and can provide an ink jet recording method using the composition. In addition, according to the embodiment, the irradiation time can be shortened due to the components of the composition, and in such a case, the printing speed is increased. Alternatively, the irradiation intensity can be reduced due to the components of the composition of the embodiment. In such a case, miniaturization of the apparatus and a reduction in cost can be achieved. The irradiation with ultraviolet light on this occasion preferably uses a UV-LED. Such a composition can be prepared by including at least one of a photopolymerization initiator that is decomposed by irradiation with ultraviolet light of a wavelength within the above-mentioned range and a polymerizable compound that initiates polymerization by irradiation with ultraviolet light of a wavelength within the above-mentioned range. The above-mentioned wavelength range may include one emission peak wavelength or two or more emission peak wavelengths. Even if two or more emission peak wavelengths exist, the total irradiation energy of the ultraviolet light having the above-mentioned emission peak wavelengths is defined as the irradiation energy.

### EXAMPLES

The present invention will now be more specifically described by examples, but is not limited to the following examples.

### Raw Materials for Composition

The raw materials used in the following examples and comparative examples are as follows.

Monomer A

2-(2-Vinyloxyethoxy)ethyl acrylate (manufactured by Nippon Shokubai Co., Ltd., Product name: VEEA, hereinafter abbreviated to “VEEA”)

Monomer B

Cyclic trimethylolpropane formal acrylate (manufactured by Osaka Organic Chemical Industry Ltd., Product name: Viscoat #200, hereinafter abbreviated to “CTFA”)

4-Acryloyloxymethyl-2-methyl-2-ethyl-1,3-dioxolane (manufactured by Osaka Organic Chemical Industry Ltd., Product name: MEDOL-10, hereinafter abbreviated to “MEDOL-10”)

4-Acryloyloxymethyl-2-cyclohexyl-1,3-dioxolane (manufactured by Osaka Organic Chemical Industry Ltd., Product name: CHDOL-10, hereinafter abbreviated to “CHDOL-10”)

Monomer C

2-Phenoxyethyl acrylate (manufactured by Osaka Organic Chemical Industry Ltd., Product name: Viscoat #192, hereinafter abbreviated to “PEA”)

Benzyl acrylate (manufactured by Osaka Organic Chemical Industry Ltd., Product name: Viscoat #160, hereinafter abbreviated to “BzA”)

Other Monomer

Dipropylene glycol diacrylate (manufactured by Shin-Nakamura Chemical Co., Ltd., Product name: NK Ester APG-100, hereinafter abbreviated to “DPGDA”)

Isobornyl acrylate (manufactured by Osaka Organic Chemical Industry Ltd., Product name: IBXA, hereinafter abbreviated to “IBXA”)

N-Vinylcaprolactam (manufactured by ISP, Product name: V-CAP, hereinafter abbreviated to “nVC”)

Monomer Having One Ether Group in the Alicyclic Structure

Tetrahydrofurfuryl acrylate (manufactured by Hitachi Chemical Co., Ltd., Product name: THF-A, hereinafter abbreviated to THF-A”)

Pigment

Titanium oxide (manufactured by Ishihara Sangyo Kaisya, Ltd., Product name: CR60-2)

Dispersing Agent

Product name: Solsperse 36000, manufactured by LUBRIZOL, hereinafter abbreviated to “Sol36000”

Photopolymerization Initiator

Bis(2,4,6-trimethylbenzoyl)-phenylphosphine oxide (solid content: 100%, manufactured by BASF, Product name: IRGACURE 819, hereinafter abbreviated as “819”)

2,4,6-Trimethylbenzoyl diphenylphosphine oxide (solid content: 100%, manufactured by BASF, Product name: DAROCURE TPO, hereinafter abbreviated to “TPO”)

2,4-Diethylthioxanthone (solid content: 100%, manufactured by Nippon Kayaku Co., Ltd., Product name: KAYACURE DETX-S, hereinafter abbreviated to “DETX”)

Surfactant

Polydimethylsiloxane having a polyether-modified acrylic group (manufactured by BYK-Chemie, Product name: BYK-UV3500, hereinafter abbreviated as “BYK-UV3500”)

Polymerization Inhibitor

p-Methoxyphenol (manufactured by Kanto Chemical Co., Ltd., hereinafter abbreviated as “MEHQ”)

### Examples 1 to 19 and Comparative Examples 1 to 5

### Production of Pigment Dispersants

Prior to production of compositions, pigment dispersants were produced. Pigment (titanium oxide), a dispersing agent (Sol36000), and PEA or DPGDA were mixed so as to give a composition of dispersant A or dispersant B shown in Tables 1 and 2 and were stirred for 1 hour with a stirrer. The mixture after the stirring was dispersed with a bead mill to obtain each pigment dispersant. The dispersion conditions were a filling rate of zirconia beads having a diameter of 0.65 mm of 70%, a peripheral speed of 9 m/s, and a dispersion time of 2 to 4 hours.

### Production of Composition

The components shown in Tables 1 and 2 were added so as to give the compositions (unit: mass %) shown in Tables 1 and 2, and the mixtures were each mixed by stirring at ordinary temperature for 1 hour to completely dissolve. The pigment, the dispersing agent, and a part of PEA or DPGDA were added as a dispersant. The mixtures were each further filtered through a membrane filter of 5 μm to obtain each radiation curing type ink jet ink composition.

### Evaluation Item

The respective nozzle arrays of an ink jet printer, PX-G5000 (trade name, manufactured by Seiko Epson Corporation), were filled with the resulting radiation curing type ink jet ink compositions. A solid pattern image was printed on a vinyl chloride sheet (Viewcal 2000 (white), manufactured by Sakurai Co., Ltd.) as a recording medium at a recording resolution of 720 dpi×720 dpi and a droplet weight of 7 ng under ordinary temperature and ordinary pressure. The solid pattern image is an image formed by recording a dot for every pixel as a minimum recording unit region defined by the recording resolution. In addition to the printing, the solid pattern image was cured by irradiation with ultraviolet light having a wavelength of 395 nm at an irradiation intensity of 400 mW/cm² using a UV-LED in an ultraviolet irradiation apparatus mounted on the side of a carriage to obtain a recorded matter of a cured film adhered onto the recording medium. The image was judged to be cured when the tackiness of the image (coating film surface) was not sensed by a finger touch test.

The recorded matter was evaluated for the following evaluation items [adhesiveness of cured film], [cured film color tone (yellowness)], and [flexibility of cured film (coating film extension)]. In Example 11, the odor was sensed in the process of curing compared to other examples. In Comparative Example 1, the odor in the process of curing was stronger than that in Example 11.

### Adhesiveness of Cured Film

In order to evaluate the adhesiveness of a cured film, a single blade cutter (a commercially available cutter) as a cutting tool and a guide for making cuts at equal intervals with the single blade cutter were prepared. First, six cuts (distance between the cuts: 1 mm, the same is applied hereinafter) were made in the resulting cured film by applying the blade of the cutter so as to be vertical to the cured film. After making the six cuts, the blade was turned by 90° and further made other six cuts so as to be orthogonal to the six cuts previously made to form cuts in a grid form. Subsequently, transparent adhesive tape (width: 25±1 mm) having a length of about 75 mm was pasted to the cuts formed in the cured film in a grid form and was then sufficiently rubbed with a finger such that the cured film can be seen through the tape. Within 5 minutes from the pasting of the tape, the tape was surely peeled off from the cured film at an angle of about 600 over 0.5 to 1.0 seconds. The conditions of the cured film were then visually inspected. The evaluation criteria are as follows. The ratings A and B mean that good adhesiveness was obtained.

A: a cured film having no peeling or having peeling in 5% or less of the grids;

B: a cured film having peeling in higher than 5% and not higher than 35% of the grids; and

C: a cured film having peeling in higher than 35% of the grids.

### Cured Film Color Tone (Yellowness)

The printed and cured sample (cured film) was subjected to measurement of the b* value in the CIE/L*a*b* color system with a commercially available colorimeter (manufactured by X-Rite Inc., Product name: Gretag Macbeth Spectrolino). The evaluation criteria are as follows.

S: b* value<3,

A: 3≤b* value<5,

B: 5≤b* value<7, and

C: 7≤b* value.

### Flexibility of Cured Film (Coating Film Extension)

The recorded matter was cut into a predetermined size (the length on this occasion is defined as L0), and was set to a tensile tester (manufactured by A&D Co., Ltd.). The tensile tester was set to a tensile rate of 100 mm/min. The recorded matter was pulled with the tensile tester, and the time when cracking or peeling (hereinafter, referred to as “cracks etc.”) occurred in the cured film of the recorded matter was visually confirmed. The length of the pulled recorded matter was calculated from the time from the start of the pulling until the occurrence of cracks etc. and was defined as L1. The cracks etc. occurrence elongation (%) of the cured film (image) formed on the recording medium was calculated from the following Expression (1), and the flexibility of the cured film of the recorded matter was evaluated. The ratings A and B mean that good flexibility was obtained.

Cracks etc. occurrence elongation (%) of cured film=[(L1−L0)/L0]×100 (1)

A: cracks etc. occurrence elongation≥200%,

B: 200%>cracks etc. occurrence elongation≥100%, and

C: 100%>cracks etc. occurrence elongation.

### Hardenability

The respective nozzle arrays of an ink jet printer, PX-G5000 (trade name, manufactured by Seiko Epson Corporation), were filled with the radiation curing type ink jet ink compositions. A solid pattern image was printed on a vinyl chloride sheet (Viewcal 2000 (white), manufactured by Sakurai Co., Ltd.) as a recording medium at a recording resolution of 720 dpi×720 dpi and a droplet weight of 7 ng under ordinary temperature and ordinary pressure. The solid pattern image is an image formed by recording a dot for every pixel as a minimum recording unit region defined by the recording resolution. In addition to the printing, the solid pattern image was cured by irradiation with ultraviolet light having a wavelength of 395 nm at an irradiation intensity of 400 mW/cm² using a UV-LED in an ultraviolet irradiation apparatus mounted on the side of a carriage to obtain a recorded matter of a cured film adhered onto the recording medium. The image was judged to be cured when the tackiness of the image (coating film surface) was not sensed by a finger touch test.

The irradiation energy of the ultraviolet light required for the curing was calculated and was used for evaluation. The irradiation energy [mJ/cm²] was determined by measuring the irradiation intensity [mW/cm²] on the surface irradiated with the ultraviolet light from a light source and multiplying the resulting irradiation intensity by the irradiation duration time [s]. The irradiation intensity was measured with an ultraviolet ray intensity meter UM-10 and a receptor unit UM-400 (these are both manufactured by Konica Minolta Sensing, Inc.). The evaluation criteria are as follows. The ratings A and B mean that good hardenability was obtained.

A: irradiation energy<400 mJ/cm²,

B: 400 mJ/cm²≤irradiation energy<800 mJ/cm², and

C: 800 mJ/cm²≤irradiation energy.

### Initiator Solubility

All monomer components according to each of Examples and Comparative Examples shown in Tables 1 and 2 were weighed, were placed in a container, and were mixed. The photopolymerization initiator component shown in Tables 1 and 2 was added to the container to obtain a mixture. The mixture was stirred in a room temperature environment with a stirrer at 300 rpm, and the time necessary for completely dissolving the photopolymerization initiator into a transparent mixture was measured. If the initiator was not dissolved even after stirring for 1 hour, the container was put in an ultrasonic cleaning machine and was sonicated for minutes. After the sonication, whether the photopolymerization initiator was dissolved or not was inspected again as an indicator of solubility. The evaluation criteria are as follows.

A: the initiator was dissolved within 1 hour,

B: the initiator was dissolved after sonication, and

C: the initiator was not dissolved even after sonication.

### Viscosity

The viscosity of each of the radiation curing type ink jet ink compositions was measured at 25° C. with a DVM-E-type rotational viscometer (manufactured by Tokyo Keiki Inc.). The rotor used was a DVM-E-type cone having a cone angle of 1°34′ and a cone radius of 2.4 cm, and the rotational rate was 10 rpm. The evaluation criteria are as follows.

A: viscosity<20 mPa·s,

B: 20 mPa·s≤viscosity<25 mPa·s, and

C: 25 mPa·s≤viscosity.

TABLE 1

| | Product | Exam- | Exam- | Exam- | Exam- | Exam- | Exam- | Exam- | Exam- | Exam- | Exam- |
|---|---|---|---|---|---|---|---|---|---|---|---|
| | name | ple 1 | ple 2 | ple 3 | ple 4 | ple 5 | ple 6 | ple 7 | ple 8 | ple 9 | ple 10 |
| Dispersant A | Pigment | 13.5 | 13.5 | 13.5 | 12.15 | 13.5 | 12.15 | 13.5 | 12.15 | 13.5 | 12.15 |
| | (titanium | | | | | | | | | | |
| | oxide) | | | | | | | | | | |
| | Dispersing | 1.5 | 1.5 | 1.5 | 1.35 | 1.5 | 1.35 | 1.5 | 1.35 | 1.5 | 1.35 |
| | agent | | | | | | | | | | |
| | PEA | 15 | 15 | 15 | 13.5 | 15 | 13.5 | 15 | 13.5 | 15 | 13.5 |
| Dispersant B | Pigment | — | — | — | — | — | — | — | — | — | — |
| | (titanium | | | | | | | | | | |
| | oxide) | | | | | | | | | | |
| | Dispersing | — | — | — | — | — | — | — | — | — | — |
| | agent | | | | | | | | | | |
| | DPGDA | — | — | — | — | — | — | — | — | — | — |
| Monomer A | VEEA | 17 | 20 | 10 | 10 | 17 | 10 | 30 | 35 | 5 | 10 |
| component | | | | | | | | | | | |
| Monomer B | CTFA | 35 | 25 | 45 | 50 | 23 | 55 | 25 | 25 | 35 | 23 |
| component | MEDOL-10 | — | — | — | — | — | — | — | — | — | — |
| | CHDOL-10 | — | — | — | — | — | — | — | — | — | — |
| Monomer C | PEA | 10 | 17 | 7 | 5 | 22 | 0 | 7 | 5 | 22 | 32 |
| component | BzA | — | — | — | — | — | — | — | — | — | — |
| Other monomer | IBXA | — | — | — | — | — | — | — | — | — | — |
| component | nVC | — | — | — | — | — | — | — | — | — | — |
| | THF-A | — | — | — | — | — | — | — | — | — | — |
| Photopolymerization | TPO | 4 | 4 | 4 | 4 | 4 | 4 | 4 | 4 | 4 | 4 |
| initiator | 819 | 3 | 3 | 3 | 3 | 3 | 3 | 3 | 3 | 3 | 3 |
| | DETX | 0.5 | 0.5 | 0.5 | 0.5 | 0.5 | 0.5 | 0.5 | 0.5 | 0.5 | 0.5 |
| Surfactant | BYK- | 0.45 | 0.45 | 0.45 | 0.45 | 0.45 | 0.45 | 0.45 | 0.45 | 0.45 | 0.45 |
| | UV3500 | | | | | | | | | | |
| Polymerization | MEHQ | 0.05 | 0.05 | 0.05 | 0.05 | 0.05 | 0.05 | 0.05 | 0.05 | 0.05 | 0.05 |
| inhibitor | | | | | | | | | | | |

| | | | | | | | | | | |
|---|---|---|---|---|---|---|---|---|---|---|
| Total | 100 | 100 | 100 | 100 | 100 | 100 | 100 | 100 | 100 | 100 |
| Monomer C component total | 25.00 | 32.00 | 22.00 | 18.50 | 37.00 | 13.50 | 22.00 | 18.50 | 37.00 | 45.50 |
| Monomer B component/monomer | 1.40 | 0.78 | 2.05 | 2.70 | 0.62 | 4.07 | 1.14 | 1.35 | 0.95 | 0.51 |
| C component (mass ratio) | | | | | | | | | | |
| Adhesiveness | A | A | A | A | B | A | A | A | A | B |
| Hardenability | A | A | A | A | A | A | A | A | B | A |
| Flexibility of cured film | A | A | A | A | A | A | A | B | A | A |
| (coating film extension) | | | | | | | | | | |
| Coating film color tone | A | A | A | A | A | A | A | A | A | B |
| (yellowness) | | | | | | | | | | |
| Initiator solubility | A | A | A | A | A | B | A | A | A | A |
| Viscosity | A | A | A | A | A | A | A | A | B | A |

| | Product | Exam- | Exam- | Exam- | Exam- | Exam- | Exam- | Exam- | Exam- | Exam- |
|---|---|---|---|---|---|---|---|---|---|---|
| | name | ple 11 | ple 12 | ple 13 | ple 14 | ple 15 | ple 16 | ple 17 | ple 18 | ple 19 |
| Dispersant A | Pigment | 13.5 | 13.5 | 13.5 | 13.5 | — | — | — | — | — |
| | (titanium | | | | | | | | | |
| | oxide) | | | | | | | | | |
| | Dispersing | 1.5 | 1.5 | 1.5 | 1.5 | — | — | — | — | — |
| | agent | | | | | | | | | |
| | PEA | 15 | 15 | 15 | 15 | — | — | — | — | — |
| Dispersant B | Pigment | — | — | — | — | — | — | — | — | — |
| | (titanium | | | | | | | | | |
| | oxide) | | | | | | | | | |
| | Dispersing | — | — | — | — | — | — | — | — | — |
| | agent | | | | | | | | | |
| | DPGDA | — | — | — | — | — | — | — | — | — |
| Monomer A | VEEA | 17 | 17 | 17 | 19.3 | 25 | 25 | 25 | 25 | 25 |
| component | | | | | | | | | | |
| Monomer B | CTFA | 35 | — | — | 35 | 40 | 40 | 40 | 40 | 40 |
| component | MEDOL-10 | — | 35 | — | — | — | — | — | — | — |
| | CHDOL-10 | — | — | 35 | — | — | — | — | — | — |
| Monomer C | PEA | — | 10 | 10 | 10 | 27.4 | 26.6 | 24 | 27.2 | 25.9 |
| component | BzA | 10 | — | — | — | — | — | — | — | — |
| Other monomer | IBXA | — | — | — | — | — | — | — | — | — |
| component | nVC | — | — | — | — | — | — | — | 0.2 | 1.5 |
| | THF-A | — | — | — | — | — | — | — | — | — |
| Photopolymerization | TPO | 4 | 4 | 4 | 3 | 4 | 4 | 4.8 | 4 | 4 |
| initiator | 819 | 3 | 3 | 3 | 2 | 3 | 3 | 4.5 | 3 | 3 |
| | DETX | 0.5 | 0.5 | 0.5 | 0.2 | 0.1 | 0.9 | 1.2 | 0.1 | 0.1 |
| Surfactant | BYK- | 0.45 | 0.45 | 0.45 | 0.45 | 0.45 | 0.45 | 0.45 | 0.45 | 0.45 |
| | UV3500 | | | | | | | | | |
| Polymerization | MEHQ | 0.05 | 0.05 | 0.05 | 0.05 | 0.05 | 0.05 | 0.05 | 0.05 | 0.05 |
| inhibitor | | | | | | | | | | |

| | | | | | | | | | |
|---|---|---|---|---|---|---|---|---|---|
| Total | 100 | 100 | 100 | 100 | 100 | 100 | 100 | 100 | 100 |
| Monomer C component total | 25.00 | 25.00 | 25.00 | 25.00 | 27.40 | 26.60 | 24.00 | 27.20 | 25.90 |
| Monomer B component/monomer | 1.40 | 1.40 | 1.40 | 1.40 | 1.46 | 1.50 | 1.67 | 1.47 | 1.54 |
| C component (mass ratio) | | | | | | | | | |
| Adhesiveness | A | A | A | A | A | A | A | A | A |
| Hardenability | A | A | A | A | A | A | A | A | A |
| Flexibility of cured film | A | A | A | A | A | A | A | A | A |
| (coating film extension) | | | | | | | | | |
| Coating film color tone | A | A | A | S | A | A | B | A | B |
| (yellowness) | | | | | | | | | |
| Initiator solubility | A | A | A | A | A | A | A | A | A |
| Viscosity | A | A | A | A | A | A | A | A | A |

TABLE 2

| | Product | Comparative | Comparative | Comparative | Comparative | Comparative | Comparative |
|---|---|---|---|---|---|---|---|
| | name | Example 1 | Example 2 | Example 3 | Example 4 | Example 5 | Example 6 |
| Dispersant A | Pigment | 13.5 | 13.5 | 13.5 | — | 13.5 | 13.5 |
| | (titanium | | | | | | |
| | oxide) | | | | | | |
| | Dispersing | 1.5 | 1.5 | 1.5 | — | 1.5 | 1.5 |
| | agent | | | | | | |
| | PEA | 15 | 15 | 15 | — | 15 | 15 |
| Dispersant B | Pigment | — | — | — | 13.5 | — | — |
| | (titanium | | | | | | |
| | oxide) | | | | | | |
| | Dispersing | — | — | — | 1.5 | — | — |
| | agent | | | | | | |
| | DPGDA | — | — | — | 15 | — | — |
| Monomer A | VEEA | 13 | 22 | 17 | 23 | — | 43 |
| component | | | | | | | |
| Monomer B | CTFA | — | — | — | 39 | 40 | 15 |
| component | MEDOL-10 | — | — | — | — | — | — |
| | CHDOL-10 | — | — | — | — | — | — |
| Monomer C | PEA | 15 | 40 | 10 | — | 22 | 4 |
| component | BzA | — | — | — | — | — | — |
| Other monomer | IBXA | 34 | — | — | — | — | — |
| component | nVC | — | — | — | — | — | — |
| | THF-A | — | — | 35 | — | — | — |
| Photopolymerization | TPO | 4 | 4 | 4 | 4 | 4 | 4 |
| initiator | 819 | 3 | 3 | 3 | 3 | 3 | 3 |
| | DETX | 0.5 | 0.5 | 0.5 | 0.5 | 0.5 | 0.5 |
| Surfactant | BYK- | 0.45 | 0.45 | 0.45 | 0.45 | 0.45 | 0.45 |
| | UV3500 | | | | | | |
| Polymerization | MEHQ | 0.05 | 0.05 | 0.05 | 0.05 | 0.05 | 0.05 |
| inhibitor | | | | | | | |

| | | | | | | |
|---|---|---|---|---|---|---|
| Total | 100.00 | 100.00 | 100.00 | 100.00 | 100.00 | 100.00 |
| Monomer C component total | 30.00 | 55.00 | 25.00 | 0.00 | 37.00 | 19.00 |
| B component/C component | 0.00 | 0.00 | 0.00 | — | 1.08 | 0.79 |
| mass ratio (B/C) | | | | | | |
| Adhesiveness | C | C | C | A | B | B |
| Hardenability | B | A | A | B | C | A |
| Flexibility of cured film | A | A | A | C | A | C |
| (coating film extension) | | | | | | |
| Coating film color tone | A | B | A | A | A | A |
| (yellowness) | | | | | | |
| Initiator solubility | A | A | A | C | A | B |
| Viscosity | A | A | A | B | C | A |

In Examples, when the adhesiveness of a cured film, the hardenability, and the flexibility of the cured film are all evaluated to be good, specifically, when the adhesiveness of a cured film, the hardenability, and the flexibility of the cured film are all rated as B or higher, it can be judged that the effects of the invention are obtained.

The comparison between Examples and Comparative Examples demonstrates that the composition of the invention can provide good adhesiveness to a cured film, can have good hardenability, and can provide good flexibility to the cured film.

The results of Examples and Comparative Examples will now be examined, but the present invention is not limited to the following examination.

As obvious from the comparison of Examples 3, 7, 8, and 9, the hardenability, flexibility, and viscosity were further improved in a well-balanced state by adjusting the content of the monomer A to 10 to 30 mass % based on the total mass of the composition. It is conceived that the content of the monomer A adjusted to 10 mass % or more further improved the hardenability and further decreased the viscosity and that the content of the monomer A adjusted to 30 mass % or less relatively increased the contents of other monofunctional monomers, such as the monomer B and the monomer C, to further improve the flexibility.

As obvious from the comparison of Examples 4 to 8 and 10, the adhesiveness of a cured film, the initiator solubility, the flexibility, and the coating film color tone were further improved by adjusting the content of the monomer B to 25 to 50 mass % based on the total mass of the composition and the content of the monomer C to 18 to 45 mass % based on the total mass of the composition. It is conceived that the adhesiveness was improved by the interaction with the recording medium surface mainly because that the monomer B contained a cyclic structure having two or more ether groups, and the effects are believed to be further significant by adjusting the content of the monomer B to 25 mass % or more. It is conceived that the initiator solubility was increased mainly because that the monomer C contained an aromatic ring skeleton, and the effects are believed to be further significant by adjusting the content of the monomer B to 50 mass % or less based on the total mass of the composition and adjusting the content of the monomer C to 18 mass % or more based on the total mass of the composition. In addition, coloring is apt to occur mainly because that the monomer C contains an aromatic ring skeleton, but it is conceived that the coloring was further significantly suppressed and the coating film color tone was further improved by adjusting the content of the monomer C to 45 mass % or less based on the total mass of the composition. In addition, the flexibility was improved by containing the monomer B and the monomer C in certain amounts or more.

As obvious from the comparison Examples 1, 12, and 13, it was demonstrated that the results of each evaluation were good when the monomer B was at least one selected from the group consisting of cyclic trimethylolpropane formal acrylate, 4-acryloyloxymethyl-2-methyl-2-ethyl-1,3-dioxolane, and 4-acryloyloxymethyl-2-cyclohexyl-1,3-dioxolane.

As obvious from Examples 15 to 19, the coating film color tone was good even in a clear ink not containing a color material. Coloring is apt to occur mainly because that a monomer contains a nitrogen atom, but it is conceived that the coloring can be further suppressed by adjusting the content of the nitrogen-containing monomer to 5 mass % or less based on the total mass of the composition. It is conceived that coloring derived from an acylphosphine oxide compound can be suppressed while maintaining good characteristics of a cured film, such as adhesiveness, hardenability, and flexibility, by adjusting the content of the acylphosphine oxide compound as an initiator to 9 mass % or less based on the total mass of the composition.

The comparison of Examples 2, 4 to 6, and 10 demonstrates that the adhesiveness, coating film color tone, and initiator solubility were well balanced by adjusting the mass ratio of the monomer B to the monomer C (monomer B/monomer C) to 0.7 to 3.0. It is conceived that the adhesiveness was improved by the interaction with the recording medium surface mainly because that the monomer B contained a cyclic structure having two or more ether groups, and the effects are believed to be further significant when the mass ratio of the monomer B to the monomer C was 0.7 or more, i.e., when the relative content of the monomer B was a certain value or more. Coloring is apt to occur mainly because that the monomer C contains an aromatic ring skeleton, but it is conceived that the coloring was further significantly suppressed by adjusting the relative content of the monomer C to a certain value or less. It is also conceived that the initiator solubility was increased mainly because that the monomer C contained an aromatic ring skeleton, and the effects are believed to be further significant when the mass ratio of the monomer B to the monomer C was 3.0 or less, i.e., when the relative content of the monomer C was a certain value or more.

In Example 11, odor was sensed during the process of curing compared to other Examples. In Comparative Example 1, strong odor was sensed during the process of curing compared to Example 11. These results demonstrate that PEA is preferred compared to BzA from the viewpoint that the odor is highly decreased. It was also demonstrated that the monomer B (in particular, CTFA) is preferred compared to IBXA from the viewpoint that the odor is highly decreased. This is believed to be caused by that the monomer B included a cyclic skeleton having two or more ether groups, which increased the polarity compared to the case of an alicyclic structure.

The entire disclosure of Japanese Patent Application No. 2017-059852, filed Mar. 24, 2017 is expressly incorporated by reference herein.

What is claimed is:

1. A radiation curing type ink jet ink composition comprising:
a monomer A represented by Formula (I):
CH₂═CR¹—COOR²—O—CH═CH—R³
(where, R¹ represents a hydrogen atom or a methyl group; R² represents a divalent organic residue having 2 to 20 carbon atoms; R³ represents a hydrogen atom or a monovalent organic residue having 1 to 11 carbon atoms);
a monofunctional (meth)acrylate monomer B including a cyclic ether skeleton having two or more ether groups;
a monofunctional (meth)acrylate monomer C including an aromatic ring skeleton; and
a photopolymerization initiator, wherein
a content of the monomer A is 5 to 35 mass % based on the total mass of the composition;
a content of the monomer B is 23 to 55 mass % based on the total mass of the composition; and
a content of the monomer C is 13 to 46 mass % based on the total mass of the composition.

2. The radiation curing type ink jet ink composition according to claim 1, wherein
the content of the monomer A is 10 to 30 mass % based on the total mass of the composition.

3. The radiation curing type ink jet ink composition according to claim 1, wherein
the content of the monomer B is 25 to 50 mass % based on the total mass of the composition; and
the content of the monomer C is 18 to 45 mass % based on the total mass of the composition.

4. The radiation curing type ink jet ink composition according to claim 1, wherein
the monomer B is at least one selected from the group consisting of cyclic trimethylolpropane formal acrylate, 4-acryloyloxymethyl-2-methyl-2-ethyl-1,3-dioxolane, and 4-acryloyloxymethyl-2-cyclohexyl-1,3-dioxolane.

5. The radiation curing type ink jet ink composition according to claim 1, further comprising a color material, wherein
the color material includes a white pigment.

6. The radiation curing type ink jet ink composition according to claim 5, wherein
a content of the color material is 5 to 30 mass % based on the total mass of the composition.

7. The radiation curing type ink jet ink composition according to claim 1, wherein
a content of the color material is 0.5 mass % or less based on the total mass of the composition.

8. The radiation curing type ink jet ink composition according to claim 7, wherein
the ink jet composition is a clear ink composition.

9. The radiation curing type ink jet ink composition according to claim 1, wherein
a content of a nitrogen-containing monomer is 5 mass % or less based on the total mass of the composition.

10. The radiation curing type ink jet ink composition according to claim 1, wherein
the photopolymerization initiator includes an acylphosphine oxide compound; and
a content of the acylphosphine oxide compound is 9 mass % or less based on the total mass of the composition.

11. The radiation curing type ink jet ink composition according to claim 10, wherein
the acylphosphine oxide compound includes a bisacylphosphine oxide compound and a monoacylphosphine oxide compound.

12. The radiation curing type ink jet ink composition according to claim 1, wherein
the photopolymerization initiator includes a thioxanthone compound; and
a content of the thioxanthone compound is 1 mass % or less based on the total mass of the composition.

13. The radiation curing type ink jet ink composition according to claim 1, wherein
a mass ratio of the monomer B to the monomer C (monomer B/monomer C) is 0.7 to 3.0.

14. An ink jet recording method comprising:
discharging the radiation curing type ink jet ink composition according to claim 1 onto a recording medium; and
irradiating the composition discharged on the recording medium with radiation and curing the composition.

15. An ink jet recording method comprising:
discharging the radiation curing type ink jet ink composition according to claim 2 onto a recording medium; and
irradiating the composition discharged on the recording medium with radiation and curing the composition.

16. An ink jet recording method comprising:
discharging the radiation curing type ink jet ink composition according to claim 3 onto a recording medium; and
irradiating the composition discharged on the recording medium with radiation and curing the composition.

17. An ink jet recording method comprising:
discharging the radiation curing type ink jet ink composition according to claim 4 onto a recording medium; and
irradiating the composition discharged on the recording medium with radiation and curing the composition.

18. An ink jet recording method comprising:
discharging the radiation curing type ink jet ink composition according to claim 5 onto a recording medium; and
irradiating the composition discharged on the recording medium with radiation and curing the composition.

19. An ink jet recording method comprising:
discharging the radiation curing type ink jet ink composition according to claim 6 onto a recording medium; and
irradiating the composition discharged on the recording medium with radiation and curing the composition.

20. The ink jet recording method according to claim 14, wherein
the curing is performed with an irradiation energy of less than 800 mJ/cm².
